(19) United States
(12) Patent Application Publication
(10) Pub. No.: US 2024/0382844 A1
(43) Pub. Date: Nov. 21, 2024

(54) GAME SERVER RESOURCE MANAGEMENT SYSTEM, METHOD, AND A RECORDING MEDIUM STORING A PROGRAM EXECUTING THE METHOD

(71) Applicant: FUNNY STORM, Seongnam-si (KR)

(72) Inventors: Chunggil YU, Suwon-si (KR); Jeong-Hwan IM, Hanam-si (KR)

(73) Assignee: FUNNY STORM, Seongnam-si (KR)

(21) Appl. No.: 18/665,296

(22) Filed: May 15, 2024

(30) Foreign Application Priority Data
May 18, 2023 (KR) 10-2023-0064608
Feb. 8, 2024 (KR) 10-2024-0019994

(51) Int. Cl. A63F 13/352; A63F 13/216; A63F 13/69

(52) U.S. Cl. CPC A63F 13/352; A63F 13/216; A63F 13/69

(57) ABSTRACT

The present invention relates to a game server resource management system, a method, and a recording medium storing programs that execute the method, and the method includes providing a client program to a connected client terminal; and providing player information to generate a virtual game environment and execute game play through a player by the client terminal, wherein the client program may include a matching table between a real environment to which a game service user belongs and the generated game environment, and when the user runs the game, the client terminal may generate a virtual game environment based on the matching table. According to the present invention, unnecessary server usage costs and communication costs due to server calls can be reduced, and resource management for the server can be performed efficiently.

### CROSS-REFERENCE TO RELATED APPLICATION

This application claims priority to and the benefit of Korean Patent Application No. 10-2023-0064608 filed in the Korean Intellectual Property Office on May 18, 2023, and Korean Patent Application No. 10-2024-0019994 filed in the Korean Intellectual Property Office on Feb. 8, 2024, the entire contents of which are incorporated herein by reference.

### BACKGROUND OF THE INVENTION

### (a) Field of the Invention

The present invention relates to a game server resource management system, a method, and a recording medium storing the method, and it relates to a technology for generating an initial virtual space by a client terminal based on a client-based table on a game, and storing changed elements according to interaction with a player on a server and reflecting the changed element in the virtual space for the game.

### (b) Description of the Related Art

With the development of mobile technology, the time and space constraints of building games are becoming less while game players are becoming more interactive. As game consumers have diversified, there have been various attempts to merge the gaming space with the real world.

Traditionally, the game server stores and manages all the information about the necessary objects and sub-elements in the game for generating a game space and playing a game. This resulted in a lot of server costs.

Especially for games, such as metaverse games based on real-world spaces, where the size of the game space increases and many participants connect and play together at the same time, there is an urgent need for efficient management of server resources.

### SUMMARY OF THE INVENTION

Therefore, the technical object that the present invention aims to solve is to enable the client terminal and game server to disperse and process the creation and management of necessary objects and sub-elements in the game for creating a game space and user play.

In addition, the technical object that the present invention aims to solve is to provide users with an experience similar to a real-time online game even with a small amount of server data.

A system, as a game server resource management system according to an aspect of the present invention to solve the technical object includes: a service server that receives member information of a game service user from a client terminal, registers the member information and performs member management; and a game server that provides a client program for game execution on the client terminal, wherein the client program includes a matching table between a real environment to which the game service user belongs and a generated game environment, and when the user runs the game, the client terminal generates a virtual game environment based on the matching table.

In this case, when the user runs the game, the client program may receive real environment information to which the user belongs based on GPS values from a relevant API or map server, and generate a virtual game environment that matches the real environment information based on the matching table.

In addition, the game server may include: a client program providing unit providing the client program; an interaction confirmation unit that confirms changed elements from interaction of a player in a game environment, and generates interaction data; a non-volatile storage processor that continuously stores non-volatile data among the interaction data and provides the non-volatile data to the client terminal upon user connection such that changed elements are incorporated when the client terminal generates a virtual game environment; and a volatile storage processor that stores volatile data among the interaction data and provides the volatile data to the client terminal upon user connection such that changed elements are incorporated when the client terminal generates a virtual game environment.

In addition, the non-volatile data may be information related to the player's growth and includes one or more of experiences, a level, equipment, and goods.

In addition, the volatile data may be temporary interaction data of the player, and the volatile storage processor may delete the volatile data when one or more of the following occurs: when a predetermined period for the volatile data has elapsed, when there is no utilization during the predetermined period, and when the number of utilizations is less than a predetermined number.

Alternatively, the volatile data may be temporary interaction data of the player, and the volatile storage processor may execute deletion or overwriting of data when receiving a deletion or overwrite request from the client terminal.

A game server resource management method of a system according to an aspect of the present invention to solve the technical object may include: providing a client program to a connected client terminal; and providing player information to generate a virtual game environment and execute game play through a player by the client terminal, wherein the client program may include a matching table between a real environment to which a game service user belongs and the generated game environment, and when the user runs the game, the client terminal may generate a virtual game environment based on the matching table.

When the user runs the game, the client program may receive real environment information to which the user belongs based on GPS values from a relevant API or map server, and generate a virtual game environment that matches the real environment information based on the matching table.

In addition, the method may further include: confirming changed elements from a player's interaction in a game environment during the game play, and generating interaction data; and storing the interaction data as non-volatile data or volatile data.

The method may further include providing the interaction data to the client terminal upon user reconnection to the game such that changed elements are incorporated when the client terminal generates a virtual game environment

Meanwhile, the non-volatile data may be information related to the player's growth and may be continuously stored, including one or more of experience, level, equipment, and goods.

The method may further include, when the interaction data is stored as volatile data as temporary interaction data of the player, deleting the volatile data when one or more of the following occurs: when a predetermined period for the volatile data has elapsed, when there is no utilization during the predetermined period, and when the number of utilizations is less than a predetermined number.

Alternatively, the method may further include, when the interaction data is stored as volatile data as temporary interaction data of the player, executing deletion or overwriting of the corresponding data when receiving a deletion or overwrite request for the corresponding data from the client terminal.

In addition, a recording medium according to an aspect of the present invention to solve the technical object is a recording medium that stores a program that executes a game server resource management method, and the method may include: storing a matching table between a real space and a virtual space required to generate a game space by a client terminal; and receiving current real environment information and geographical information based on GPS values, and generating a virtual game environment that matches the real space based on the matching table by the client terminal.

in generating the virtual game environment, upon receiving interaction data from player interaction in the previous game play, changed elements are incorporated into the virtual game environment by applying the interaction data.

As described above, according to the present invention, the client terminal and the game server disperse and process the creation and management of necessary objects and sub-elements within the game, thereby reducing server costs and enabling efficient resource management.

In particular, the initial game space is created based on a client-based table in the client terminal, and only the elements changed by the player's interaction are saved on the server and applied to the virtual space, and therefore experiences similar to a real-time online game can be provided with only a small amount of server data.

### BRIEF DESCRIPTION OF THE DRAWINGS

FIG. 1 is a diagram illustrating an entire game server resource management system according to an aspect of the present invention.

FIG. 2 is a schematic diagram of a service server according to an aspect of the present invention.

FIG. 3 is a diagram illustrating a game server according to an aspect of the present invention.

FIG. 4 shows a table for comparison of non-volatile data and volatile data as interaction data generated and managed by the game server according to an aspect of the present invention.

FIGS. 5(a) and 5(b) exemplarily show volatile data according to an aspect of the present invention.

FIGS. 6(a) and 6(b) exemplarily show non-volatile data according to an aspect of the present invention.

FIG. 7 is a detailed schematic diagram of the client terminal according to an aspect of the present invention.

FIG. 8 is a detailed schematic diagram of a real environment information request unit in FIG. 7.

FIG. 9 is a detailed schematic diagram of a game environment configuration unit of FIG. 7.

FIG. 10 is an example of a predefined client-based matching table according to an aspect of the present invention.

FIG. 11 is an entire flowchart that creates and manages necessary objects and sub-elements in the game according to an aspect of the present invention.

FIG. 12 is an entire flowchart that creates a virtual game environment in the client terminal according to an aspect of the present invention.

### DETAILED DESCRIPTION OF THE EMBODIMENTS

Hereinafter, exemplary embodiments of the present invention will be described with reference to accompanying drawings so as to be easily understood by a person ordinary skilled in the art. However, the present invention can be variously implemented and is not limited to the following embodiments. Accordingly, the drawings and description are to be regarded as illustrative in nature and not restrictive. Like reference numerals designate like elements throughout the specification.

In addition, through the specification, unless explicitly described to the contrary, the word “comprise”, and variations such as “comprises” or “comprising”, will be understood to imply the inclusion of stated elements but not the exclusion of any other elements.

In addition, the terms “ . . . er”, “ . . . or”, a “ . . . module” described in the specification mean units for processing at least one function and operation and can be implemented by hardware components or software components and combinations thereof.

The devices described in the present invention are formed of hardware including at least one processor, a memory device, a communication device, and the like, and a program executable in combination with the hardware is stored at a designated location. The hardware has the configuration and performance to execute the method of the present invention. The program includes instructions implementing the method of the operation of the present invention described with reference to the drawings, and is combined with hardware, such as a processor and memory device, to execute the present invention.

In the present specification, “transmit or provide” may include not only direct transmission or provision, but also indirect transmission or provision through another device or by utilizing a bypass path.

In the present specification, expressions in the singular may be construed as either singular or plural, unless the explicit words “one” or “single” or the like are used.

In the present specification, regardless of the drawing, the same reference numeral refers to the same component, and “and/or” includes each and every combination of one or more of the recited components.

Terms including an ordinary number, such as first and second, are used for describing various constituent elements, but the constituent elements are not limited by the terms. The terms are used only to discriminate one constituent element from another constituent element. For example, without departing from the scope of the present disclosure, the first component may be named as the second component, and similarly, the second component may be named as the first component.

In the flowchart described with reference to the drawing, the order of operations may be changed, several operations may be merged, some operations may be divided, and specific operations may not be performed.

The present invention is a technology that allows efficient use of server resources in a virtual game space for game play on a client terminal.

Traditionally, game servers store and manage all information on all objects and sub-elements needed within the game for users to play the game, resulting in high server costs.

However, according to the present invention, the initial game space may be generated by a client terminal by a predefined client-based table.

Then, if changes occur in the game space due to the player's in-game interactions, the game server may only store the corresponding changed elements. In this case, the stored data includes both volatility and non-volatility.

In addition, when the player reconnects to the game, the client terminal may receive the saved changed elements from the game server and apply them to the virtual game space.

The game server may store both volatile data and non-volatile data related to the game's virtual space, and player information related to player growth may be permanently stored as non-volatile data. In addition, temporary interaction data of the player may be deleted after a certain period of time or if it is not used for a certain period of time.

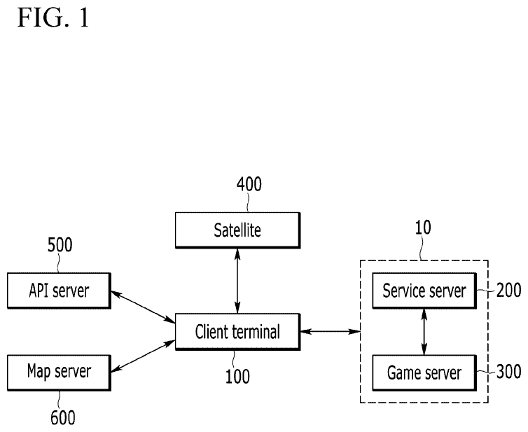

More specifically, as shown in FIG. 1, a user may play a game through a client terminal 100.

The client terminal 100 may be, for example, a mobile terminal and may access a game server 300 to download a client program and play a target game. In this case, the client terminal 100 may register as a member through information registration and receive member services through a service server 200.

The client terminal 100 may receive GPS information through a satellite 400.

In addition, the client terminal 100 may receive real environment data and map data based on a current position in the game space through an API server 500 and a map server 600. This allows information about the current weather, temperature, humidity, and time of day to be reflected in the game space in real time and interaction with the game.

That is, according to the present invention, the client terminal 100 may call the map server 600 and the API server 500 by utilizing the GPS information.

In addition, the client terminal 100 may configure a virtual game environment based on client-based table information defined in advance and downloaded from the game server 300, utilizing the information from the map server 600 or the API server 500. The game spaces may be interacted with each other based on real environment data, and thus it is possible to provide users with an immersive and diverse gaming experience.

Various elements that can be obtained through the API, such as temperature, country, weather, altitude, time, wind, fog, ultraviolet rays, precipitation, and fine dust, are composed as a game environment that is matched based on the client-based table, and thus the player may enjoy a game in a game environment that is associated with the real world.

For example, as a temperature-based game environment configuration, for environments above 30 degrees, tropical and desert plants, such as broadleaf trees and cacti, animals adapted to hot climates, such as camels and desert foxes, and monsters and dragons that only appear when temperatures are high may be provided. Further, enemies that do not like heat may be weakened, and enemies that like hot may be strengthened.

If the temperature is 0 degrees Celsius or lower, cold-hardy plants, such as conifers and leafless trees, animals adapted to cold climates, such as penguins and polar bears, and monsters and dragons that only come out when the temperature is low may be provided. Enemies that like cold may be strengthened and enemies that do not like cold may be weakened.

The elements are illustrative, and the game environment may be configured in the client terminal 100 based on the matching table and interaction is possible by utilizing a variety of information obtained from the map server, a weather API, and the like.

That is, by utilizing the GPS function of the client terminal 100 that reflects the user's real-world location, the client terminal 100 may receive weather information and the like of the corresponding location, and may configure a virtual game environment based on the table stored in the client terminal 100 regardless of the game server 300.

In this case, when a player starts playing the game and interacting with a specific object in the game space, sub-elements of the object, that is, interaction data, may be created.

The game server 300 may store and manage the interaction data.

The game server 300 may provide a client program for game play according to a request of the client terminal 100 and may provide player data to start the game. In this case, the game server 300 may also provide interaction data generated by the player's in-game interaction in the previous connection.

The game server 300 may manage the interaction data by dividing it into volatile data and non-volatile data.

The service server 200 may manage user connections, register member information of game service users, and perform member management.

The API server 500 may provide environmental information on the current position based on a GPS value of the client terminal 100 confirmed from the satellite 400.

For example, the API server 500 may provide various environmental information according to the request of the client terminal 100, such as weather, temperature, wind speed, precipitation, and fine dust.

The map server 600 may provide the requested map data using the GPS value of the client terminal 100 as a reference.

The map server 600 may provide map data in tile format that represents geographic characteristics of the region.

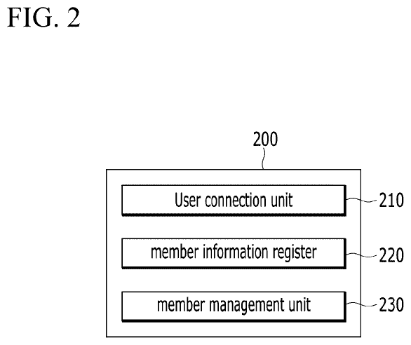

FIG. 2 is a detailed schematic diagram of the service server 200 according to an aspect of the present invention.

As shown in the drawing, the service server 200 may include a user connection unit 210, a member information register 220, and a member management unit 230.

The user connection unit 210 is an interface with the client terminal 100 and may receive requests and information from the client terminal 100.

The member information register 220 may collect and register information about users registering as members.

The member management unit 230 may manage the history of registered members or set/manage events provided to members.

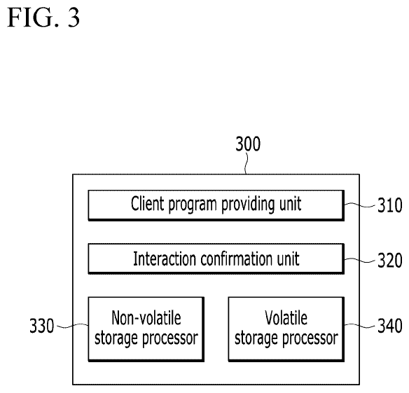

Hereinafter, referring to FIG. 3, the game server 300 according to an aspect of the present invention will be described in more detail.

The game server 300 may include a client program providing unit 310, an interaction confirmation unit 320, a non-volatile storage processor 330, and a volatile storage processor 340.

The client program providing unit 310 may provide the client terminal 100 with a program necessary to play the game.

The client program providing unit 310 also provides a table that defines a virtual space that matches according to information on a real environment where the user is positioned such that the client terminal 100 can configure a virtual game space that matches according to the received real environment information without the game server 300.

The interaction confirmation unit 320 may check the interaction between the player and objects in the game space, sub-elements generated according to the interaction, and the environmental changes and generate interaction data.

For example, the interaction confirmation unit 320 may generate data related to killing a monster when the player kills a specific monster in a specific area of the virtual game space.

Alternatively, the interaction confirmation unit 320 may generate the corresponding data as interaction data when the player acquires a specific item or experience level in the game.

The non-volatile storage processor 330 store and provide non-volatile interaction data that is continuously maintained by the game server 300 among the interaction data and provided to the client terminal 100 each time the client terminal 100 is connected.

The volatile storage processor 340 may store and provide volatile interaction data that is temporarily maintained in the game server 300 among the interaction data.

The volatile storage processor 340 may delete volatile interaction data that has passed a certain amount of time after storage or has not been utilized for a certain amount of time.

Alternatively, the volatile storage processor 340 may delete the corresponding data when receiving a deletion request from the client terminal 100.

Alternatively, the volatile storage processor 340 may process data by overwriting it with other data when there is an overwrite request from the client terminal 100.

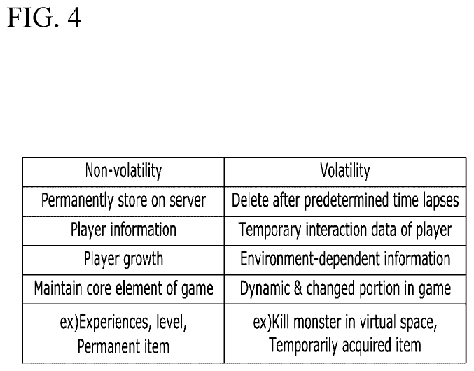

FIG. 4 shows a table of comparison of non-volatile data and volatile data as interaction data generated and managed by the game server 300 according to an aspect of the present invention.

First of all, non-volatile data among the interaction data is data that is continuously stored in the game server 300, and is data related to player information and player growth.

The non-volatile data is a core element of the game and is maintained on the game server 300 and is also maintained upon the next connection of the player and provided to the client terminal 100.

For example, the non-volatile data includes player's experiences acquired in the virtual game space, a player's level, goods, or equipment, and the like.

The game server 300 may provide continuity to the player's game experience by permanently storing and providing non-volatile data while the user maintains membership.

Among the interaction data, volatile data is data of the player's temporary interaction, and the game server 300 may delete the data after a certain period of time.

Volatile data is environment-dependent information and may include elements that change dynamically in the game.

For example, when a player kills a monster in a virtual game space, the data is stored, and thus when the player reconnects, the monster may not appear in that area, and items temporarily acquired by the player may be managed as volatile data.

In addition, for example, when a certain period of time passes, the information is volatilized, and thus when the player reconnects, monsters may reappear in the area, and items acquired and collected by the player in the area may reappear in the game space.

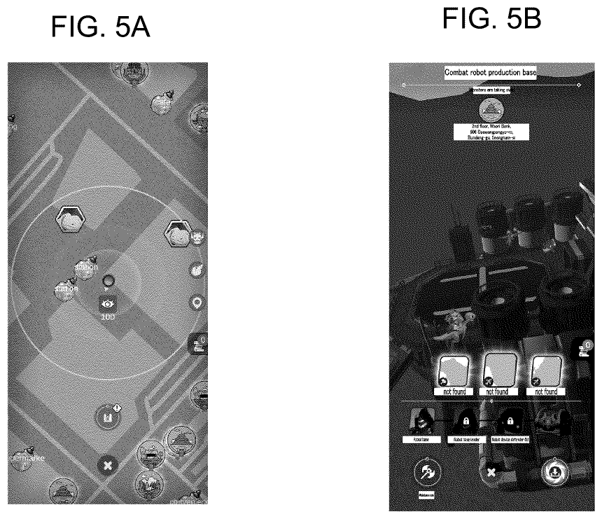

FIG. 5 illustrates the volatile data in the game space in more detail.

First, for example, as shown in FIG. 5(a), a region 100 m around the player is set as a range that the player may influence in the game space and acquire items from that region.

For example, the player may acquire a water bottle-shaped item (indicated as “station” in the drawing) that may be used to purify a violent dragon, and the corresponding information may be stored on the game server 300 as volatile data.

In addition, the hexagon mark may indicate a position of a monster within the game. When a player hunts a monster, the corresponding information may also be stored on the game server 300 as volatile data.

The region outside the player activity region is a space matched according to geographical information of the real space and is a dungeon in the game that the player can enter. When the player enters, the region may be activated in an original color and may be shown, for example, in FIG. 5(b).

In addition, as shown in FIG. 5(b), the player may hunt a monster or a dragon in the dungeon the player entered.

In this case, an experience gained by the player from hunting is stored as non-volatile data, while information about hunted monsters or dragons may be stored as volatile data on the game server 300.

After that, when the player accesses the game, the game space may be configured in a region or dungeon without existence of any specific collected or hunted items or monsters.

Then, when a predetermined time elapses or there is a deletion or overwrite request from the client terminal 100, the information is volatilized from the game server 300 and when the player reconnects to the game, the corresponding area may be configured as an environment where specific items or monsters exist.

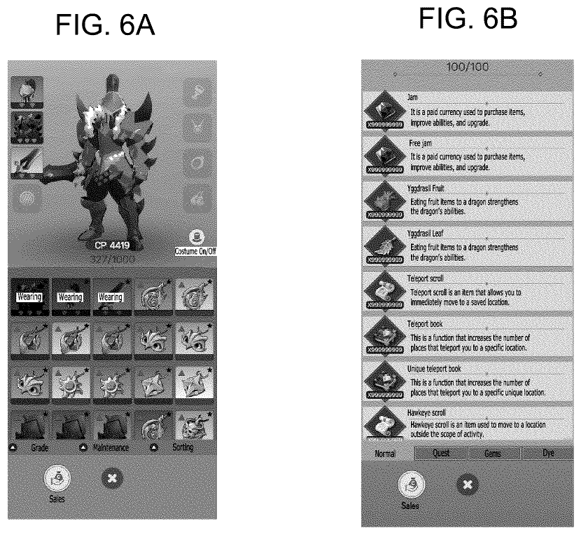

Meanwhile, as shown in FIG. 6, elements owned by the player, such as experience points, equipment, and items acquired while playing the game, are non-volatile data and may be continuously maintained and stored on the game server 300.

Specifically, as shown in FIG. 6(a) and FIG. 6(b), the equipment and items acquired by the user may be stored on the game server 300 as non-volatile data.

Then, when the player reconnects to the game, the game server 300 may provide the stored non-volatile data to the client terminal 100 such that it can be applied to the game status.

Therefore, according to the present invention, a large-scaled structure of the virtual space for game play is determined and configured by a client-based table, and only data that the player interacts with in the virtual space is managed by the game server 300 and is provided to the client terminal 100 when connecting to the game such that changes can be applied to necessary areas.

In addition, in the present invention, interaction data is managed by dividing it into volatile data and non-volatile data, and thus server resource management efficiency can be further improved.

As a result, the efficiency of the data storage is maximized and the server resource burden required for creating a complex virtual game space can be minimized.

In other words, according to the present invention, the large-scaled structure of the virtual space is determined by the client table, and detailed changes due to player interaction can be reflected in real-time using minimal server data.

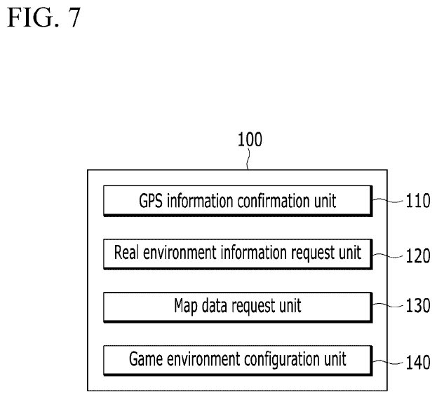

FIG. 7 is a detailed schematic diagram of the client terminal 100 according to an aspect of the present invention.

As shown in the drawing, the client terminal 100 may include a GPS information confirmation unit 110, a real environment information request unit 120, a map data request unit 130, and a game environment configuration unit 140.

The GPS information confirmation unit 110 may confirm the current position information of the client terminal 100 through a satellite.

The real environment information request unit 120 may request and receive real environment information from the API server 500 based on GPS values.

For example, the real environment information request unit 120 may receive various real environment information such as weather, temperature, wind speed, precipitation, and fine dust at the corresponding position through the API server 500.

The map data request unit 130 may request map data from the map server 600 using the player's GPS position as a reference, and, for example, may receive map data in tile format representing the geographical characteristics of the area.

The game environment configuration unit 140 may configure the player's virtual game space through a virtual game space configuration matching table downloaded in advance from the game server 300.

The game environment configuration unit 140 generates a large-scaled structure of the virtual space by matching real environment conditions and geographical information based on the table, and receives interaction data generated by player interaction from the game server 300, thereby applying detailed changes to the virtual space in real time.

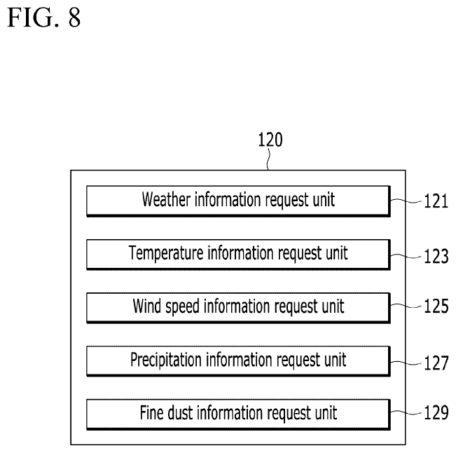

More specifically, as shown in FIG. 8, the real environment information request unit 120 includes a weather information request unit 121, a temperature information request unit 123, a wind speed information request unit 125, a precipitation information request unit 127, and a fine dust information request unit 129, and may request and receive real environment information such as weather, temperature, wind speed, precipitation, and fine dust from the corresponding API server 500.

In addition, the configuration is an exemplary embodiment, and much more real environment information can be requested and received.

For example, the real environment information request unit 120 may receive stock price information of the corresponding country and traffic information of the corresponding region and use them to configure the game environment.

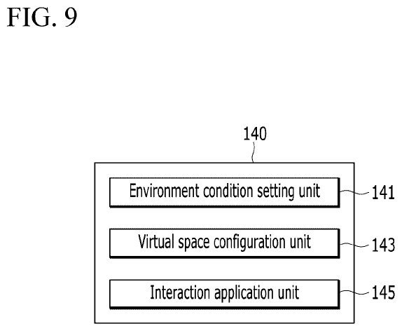

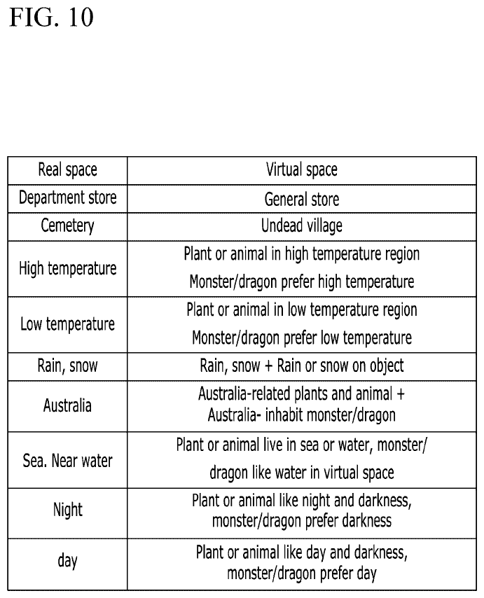

Hereinafter, referring to FIG. 9 and FIG. 10, the above-described game environment configuration unit 140 will be described in more detail.

As shown in the drawings, the game environment configuration unit 140 may include an environment condition setting unit 141, a virtual space configuration unit 143, and an interaction application unit 145.

The environment condition setting unit 141 may set a current environmental condition and geographical condition received by a request.

For example, the environment condition setting unit 141 may set an apartment complex with geographical information of a space where the player is positioned using a GPS reference, and may set weather information such as rain or snow, precipitation information, and the current night time.

The virtual space configuration unit 143 may immediately configure a matching virtual game space using a pre-stored table based on the settings.

FIG. 10 is an example of a matching table between the real environment and the virtual space.

As shown in the drawing, for example, when the geographical information provided in the map data of the area where the player is currently positioned includes a department store, apartment complex, or cemetery, the game space may be configured of a general store, an orc village, or an undead village, respectively.

In addition, when the temperature of the current position is high temperature, a real animal or plant that lives in a high temperature region or a monster or dragon set to prefer high temperature in the game may be configured in the game environment.

In addition, when the temperature of the current position is low temperature, a monster or dragon set to prefer low temperature in the game space or a real plant or animal that inhabits in a low temperature region may appear in the game environment.

Similarly, when it is raining or snowing in real environment, rain or snow may be expressed in the corresponding game space, and rainwater or snow may be expressed on each object in the game.

In addition, for example, when the player's real position is Australia, plants related to Australia and monsters or dragons set to inhabit Australia may appear in the game space.

In addition, when the player's current position is near the sea or water, plants and animals that live in the sea or water in the real world may appear in the virtual game space, and monsters or dragons set to like water may appear in the game.

When the player's real environment is night or day, the virtual space configuration unit 143 may set an environment of plants or animals that set to like night and darkness, a monster or dragon set to prefer darkness, or plants or animals set to like light or a monster or dragon set to prefer day as a matching virtual space.

The interaction application unit 145 may apply detailed changes due to player interaction to the large-scaled structure of the virtual space determined by the virtual space configuration unit 143.

The interaction application unit 145 may apply changes in real-time to necessary areas by applying the interaction data received from the game server 300 in the virtual game environment generated in the client terminal 100 based on the matching table.

In other words, according to the interaction application unit 145, monsters previously defeated by the player do not appear in the local game environment for a certain period of time, and the player's experience may be accumulated and increased each time the player connects.

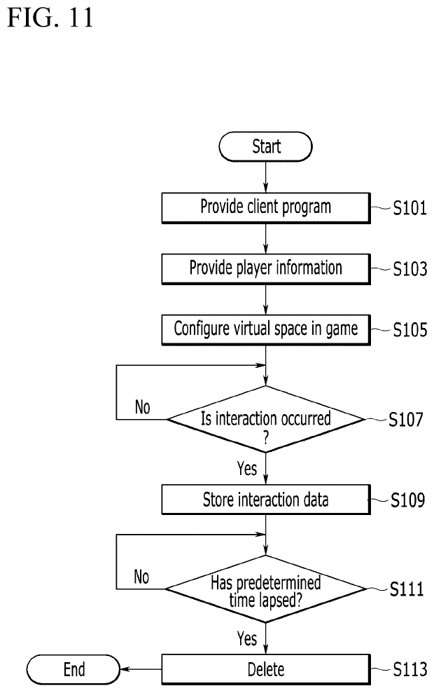

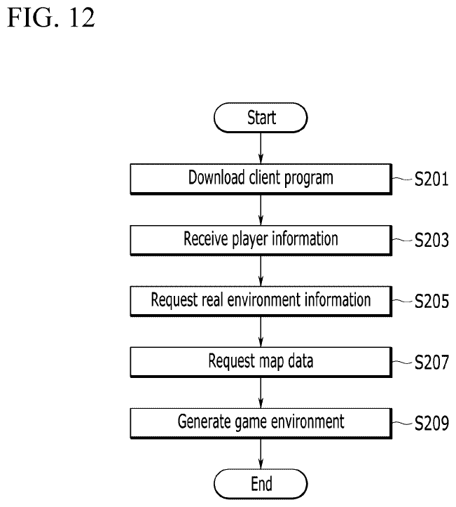

Hereinafter, referring to FIG. 11 and FIG. 12, according to an aspect of the present invention, the entire flow of generating a game environment by managing a game server resource on the game server and the client terminal will summarized and described.

First, as shown in FIG. 11, the game server 300 provides a client program to the client terminal 100 that is first connected to play the game such that a matching table between the real world and the virtual space is set to configure a virtual space, and the client terminal 100 communicates with external servers 300, 500, and 600 to execute game play (S101).

The game server 500 may provide player data such as experience points and equipment to the client terminal 100 (S103), and when other previously saved interaction data exists, the corresponding interaction data may also be provided.

The client terminal 100 may configure the virtual space within the game based on real environment information and the matching table provided from the API server 500 and the map server 60 (S105), and the detailed contents related to this will be described later with reference to FIG. 12.

In this case, when interaction data occurs in the game space due to the user's game play, the game server 300 may store the data as volatile data or non-volatile data (S107 and S109). The description of the volatile data the non-volatile data is the same as described above, and therefore it is omitted.

The game server 300 may delete the stored interaction data as volatility, when a predetermined period of time elapses or when it is not used for a certain period/a certain number of times (S111 and S113).

Alternatively, as described above, the game server 300 may perform deletion or overwriting when the interaction data is volatility and there is a request to delete or overwrite the data from the client terminal 100.

Therefore, according to the present invention, an initial game space is generated by the client terminal 100 according to a client-based table, and only the changed elements according to player interaction are stored on the game server and then provided to the terminal 100, and therefore the user can be provided with experiences similar to the real-time online game with less server data.

In other words, according to the present invention, efficiency in data processing and optimization of user experience can be achieved simultaneously, thereby providing a flexible structure applicable to various game environments.

FIG. 12 is an entire flowchart for the game environment generation method of the client terminal 100.

The client terminal 100 may download the client program required for initial connection to the game (S201), and in this case, the client terminal 100 may also be provided with a matching table between the real world and a virtual space required to create a game space.

The client terminal 100 may receive player data from the game server 300 and may receive stored interaction data (S203).

The client terminal 100 may receive real environment information and geographical information from the API server 500 and the map server 600, respectively, and generate a virtual game environment based on the pre-stored matching table of the real space and the virtual space (S205, S207, and S209).

In this case, when the client terminal 100 receives interaction data, changed elements are incorporated into the virtual game environment, thereby reflecting detailed changes according to player interaction in real-time.

As described above, according to the present invention, the initial game space can be generated according to a client-based table based on user position and corresponding real environment information. After that, when a change occurs in the game space due to the player's interaction, only the corresponding changed element may be stored in the game server.

The stored data includes both volatile data and non-volatile data, and when the player reconnects to the game, the changes may be applied to the game space and newly configured according to the interaction data received from the game server.

Since the processes are executed through a client-based configuration, it is possible to provide users with an experience similar to a real-time online game with less server data.

The virtual space continuously changes according to changes in user position, passage of time, and changes in environmental conditions, and various situations are defined in the client table in advance, and thus there is no significant data consumption in the client terminal.

In other words, according to the present invention, data processing efficiency and user experience optimization can be achieved simultaneously.

The exemplary embodiment of the present disclosure described above is not implemented only through the apparatus and method, and may be implemented through a program for realizing a function corresponding to the configuration of the exemplary embodiment of the present disclosure or a recording medium in which the program is recorded.

Although the exemplary embodiment of the present disclosure has been described in detail hereinabove, the scope of the present disclosure is not limited thereto. That is, several modifications and alterations made by a person of ordinary skill in the art using a basic concept of the present disclosure as defined in the claims fall within the scope of the present disclosure.

### DESCRIPTION OF SYMBOLS

100: client terminal
110: GPS information confirmation unit
120: real environment information request unit
121: weather information request unit
123: temperature information request unit
125: wind speed information request unit
127: precipitation information request unit
129: fine dust information request unit
130: map data request unit
140: game environment configuration unit
141: environment condition setting unit
143: virtual space configuration unit
145: Interaction application unit
200: service server
210: user connection unit
220: member information register
230: member management unit
300: game server
310: client program providing unit
320: interaction confirmation unit
330: non-volatile storage processor
340: volatile storage processor
400: satellite
500: API server
600: map server

What is claimed is:

1. A system, as a game server resource management system, comprising:
a service server that receives member information of a game service user from a client terminal, registers the member information and performs member management; and
a game server that provides a client program for game execution on the client terminal,
wherein the client program includes a matching table between a real environment to which the game service user belongs and a generated game environment, and when the user runs the game, the client terminal generates a virtual game environment based on the matching table.

2. The system of claim 1, wherein:
when the user runs the game, the client program receives real environment information to which the user belongs based on GPS values from a relevant API or map server, and generates a virtual game environment that matches the real environment information based on the matching table.

3. The system of claim 2, wherein:
the game server comprises:
a client program providing unit providing the client program;
an interaction confirmation unit that confirms changed elements from interaction of a player in a game environment, and generates interaction data;
a non-volatile storage processor that continuously stores non-volatile data among the interaction data and provides the non-volatile data to the client terminal upon user connection such that changed elements are incorporated when the client terminal generates a virtual game environment; and
a volatile storage processor that stores volatile data among the interaction data and provides the volatile data to the client terminal upon user connection such that changed elements are incorporated when the client terminal generates a virtual game environment.

4. The system of claim 3, wherein:
the non-volatile data is information related to the player's growth and includes one or more of experiences, a level, equipment, and goods.

5. The system of claim 3, wherein:
the volatile data is temporary interaction data of the player, and
the volatile storage processor deletes the volatile data when one or more of the following occurs: when a predetermined period for the volatile data has elapsed, when there is no utilization during the predetermined period, and when the number of utilizations is less than a predetermined number.

6. The system of claim 3, wherein:
the volatile data is temporary interaction data of the player, and
the volatile storage processor executes deletion or overwriting of data when receiving a deletion or overwrite request from the client terminal.

7. A game server resource management method of a system, comprising:
providing a client program to a connected client terminal; and
providing player information to generate a virtual game environment and execute game play through a player by the client terminal,
wherein the client program includes a matching table between a real environment to which a game service user belongs and the generated game environment, and when the user runs the game, the client terminal generates a virtual game environment based on the matching table.

8. The method of claim 7, wherein:
when the user runs the game, the client program receives real environment information to which the user belongs based on GPS values from a relevant API or map server, and generates a virtual game environment that matches the real environment information based on the matching table.

9. The method of claim 8, further comprising:
confirming changed elements from a player's interaction in a game environment during the game play, and generating interaction data; and
storing the interaction data as non-volatile data or volatile data.

10. The method of claim 9, further comprising:
providing the interaction data to the client terminal upon user reconnection to the game such that changed elements are incorporated when the client terminal generates a virtual game environment.

11. The method of claim 9, wherein:
the non-volatile data is information related to the player's growth and is continuously stored, including one or more of experience, level, equipment, and goods.

12. The method of claim 9, further comprising:
when the interaction data is stored as volatile data as temporary interaction data of the player,
deleting the volatile data when one or more of the following occurs: when a predetermined period for the volatile data has elapsed, when there is no utilization during the predetermined period, and when the number of utilizations is less than a predetermined number.

13. The method of claim 9, further comprising:
when the interaction data is stored as volatile data as temporary interaction data of the player,
executing deletion or overwriting of the corresponding data when receiving a deletion or overwrite request for the corresponding data from the client terminal.

14. A recording medium storing a program that executes a game server resource management method,
wherein the method comprises:
storing a matching table between a real space and a virtual space required to generate a game space by a client terminal; and
receiving current real environment information and geographical information based on GPS values, and generating a virtual game environment that matches the real space based on the matching table by the client terminal.

15. The recording medium of claim 14, wherein:
in generating the virtual game environment, upon receiving interaction data from player interaction in the previous game play, changed elements are incorporated into the virtual game environment by applying the interaction data.
